(19) United States
(12) Patent Application Publication
(10) Pub. No.: US 2017/0238501 A1
(43) Pub. Date: Aug. 24, 2017

(54) Circular Dog Toilet with Urine Removed by Pump

(71) Applicant: Donna Rae Farrell, Shelby, IA (US)

(72) Inventor: Donna Rae Farrell, Shelby, IA (US)

(21) Appl. No.: 15/049,050

(22) Filed: Feb. 20, 2016

(51) Int. Cl. A01K 1/01; B08B 9/032

(52) U.S. Cl. CPC A01K 1/011; B08B 9/032

(57) ABSTRACT

The invention is unique, not so much by the separate details many of which can be found in other devices or prior art, but by the grouping of them all together to function in an innovative way to remove the repellant odor of urine found in most previous models in a speedy, relatively effortless, economical and hygienic manner. The process is done employing a pump attached to the dog toilet's funnel to send the urine through a small hose which the owner may either manually take to the toilet and discharge it there, or the hose may be installed in the cabinetry of the bathroom with the nozzle located near the toilet, or alternately fed into the sink drain below its trap if the invention is located in a room adjacent to the bathroom.

### CROSS-REFERENCE TO RELATED APPLICATIONS

| | | | |
|---|---|---|---|
| 003818865 | 8816859 | 6792628 | 3744453 |
| 003921582 | 8196547 | 6769382 | 3672331 |
| 004979469 | D587412 | 6590146 | 6457435 |
| 007131396 | 7380518 | 5494001 | |

### BACKGROUND OF THE INVENTION

01. Small breed dogs have been successfully house broken using indoor toilets now for some number of years. This method is a boon to those who are disabled, too elderly, to walk a dog, work long hours when they are away from home and for apartment dwellers in cities or other settings where it is just easier to have the dog perform his functions indoors. In addition, some dogs particularly hate extremely cold or rainy weather, and only under great duress will they venture into such conditions.

02. But such facilities are available to only the smallest breeds. The reason this is true is that almost all of the available dog toilets gather the urine in a pan or tray in the bottom of a rectangular box. (Ref. U.S. Pat. Nos. 3,818,865, 3,921,582, 4,979,469, and 7,131,396) This urine eventually must be carried to the nearest toilet or drain and dumped—a procedure not as simple as it sounds. It is an odious task. Retained urine soon becomes exceedingly pungent with an overpowering ammonia. He who delivers it to the toiled is pretty much forced to hold his breath throughout the proceedings and the ensuing rinsing of the tray. Following is a review of one of the models with the tray arrangement which appeared on the Amazon website where it was being retailed:

### Stinky!

### By Michelle Shenkmanon Apr. 25, 2010

In theory this product works really well. My dog loved peeing on it and took to it with no problem. However, I was unaware of how disgusting it would smell. If I had thought about it (concentrated amounts of pee in one spot) I would have realized before purchasing how gross it would be. As well, if you accidentally tip it while trying to empty it, you would end up with pee all over you and the floor. While it is “eco friendly” because you are re-using the same product over and over, it is so awful that it is not worth it! The pee smell permeated throughout my condo and made me want to gag

03. Another problem with this arrangement that is also mentioned in the above review, is that even if the tray is only half full—and often it will be fuller than that, the action of walking causes a wave movement similar to carrying an overfilled cup of coffee. It may not spill, but the odds are about 50/50. The slightest misstep or lurch will be fraught with danger and likely a quantity of urine will be deposited on the floor leaving a stinky and unseemly mess to mop up. This is what happens with small dogs; feature a larger tray for a bigger dog with more urine. The tray would be unwieldy, heavier, and awkward to transport thru doorways. The product would not make a dog owner happy. That is why they haven't been manufactured successfully.

04. Other methods have been attempted also. Some with removable seats to be placed on top of the human toilet, or by placing a drain directly into the body of the invention and then carrying the whole structure to the toilet to drain it there.

The first method is not very successful because it is very difficult to train the dog to sit on a toilet. They are very resistant to that idea, although with cats the owners have been more successful.

05. A second method avoids the smell of carrying the tray full of urine by carrying the whole invention to the toilet, and tipping it, allowing it to drain from a drain-hole, but while functional for a small dog, it too would be heavy and unwieldy if, say, a German Shepherd, a Collie or a Doberman Pincher had contributed to it. And to carry the whole housing to the drain which has necessarily doubled in size for a bigger dog would be a task which a disabled person or a somewhat enfeebled elderly person would be unable to perform at all.

06. A third method involves using absorbent pads in one manner or another. This is successful for some dogs, but others insist on shedding the absorbent pads, or carrying them triumphantly around the house furled behind them like a mascot in an arena, or both. In addition, these absorbent pads also absorb odor and become quite repulsive after a rather short time, besides being relatively expensive.

07. There is another problem with the rectangular design. Almost all dogs, before they urinate like to circle, once, twice, a dozen or more times. Puppies in particular do this, and most female dogs continue to do it, while the male dogs learn to lift a hind leg and spray. The rectangular tray does not accommodate the instinctive circling movement. While circling on a rectangular platform the pup tends to misstep and comes off the platform. If he does this at the same time he is ready to urinate, then he will inadvertently spray the floor, even though his intentions were good. A dog, lifting his leg, may overshoot his target making the wall or floor of the room the recipient of his discharge.

### BRIEF SUMMARY OF THE INVENTION

08. The Circular Dog Toilet with Urine Removed by Pump solves many if not all of the above mentioned problems. By being circular it follows the dog's natural circling movement, so he does not step off by accident. By pumping the urine into a hose and the owner having to carry only the ⅜″ hose to the bathroom, there can be no spillage and almost all of the odor problem is eliminated. The hose, also, could conceivably be installed into the wall, if the toilet is in an adjoining room, and run behind or through cabinetry in the bathroom and semi-permanently attached near the toilet, (similar to the way the water line is run to the automatic freezer of the refrigerator, so the only action necessary would be to open the valve and pump. The nozzle and leading end of the hose can be installed on a hook located somewhere handy to the toilet.

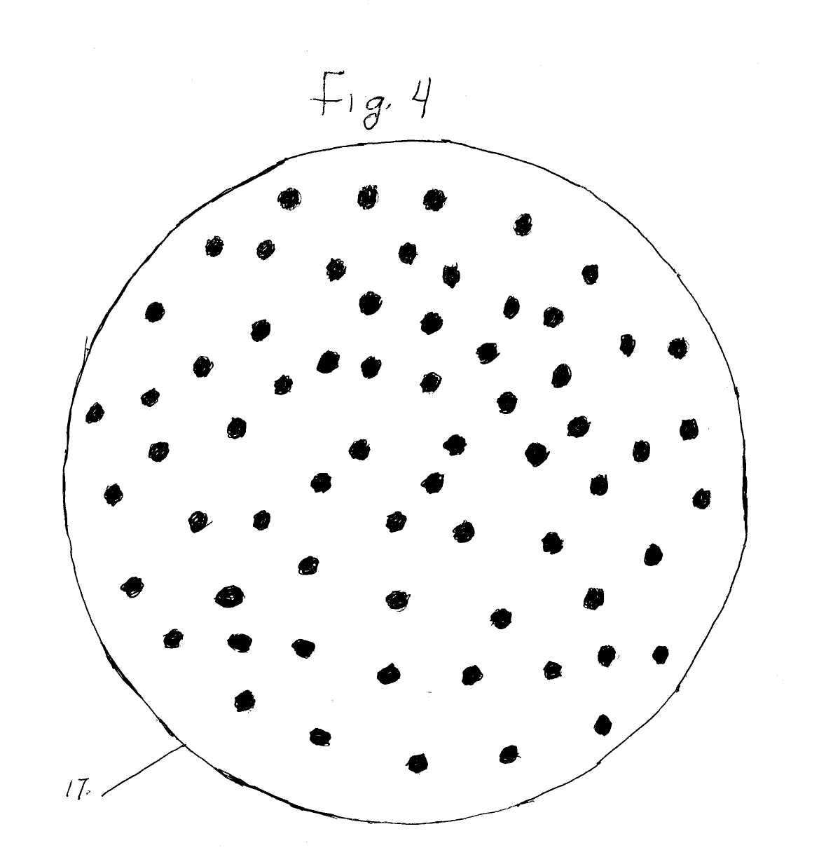

09. There is a third alternative, the best one yet, although it will not be feasible in all situations. The hose from the Circular dog Toilet can be run thru the wall as mentioned above, and installed directly below the trap of the bathroom sink. See FIG. 4. This would be ideal, because then the owner has only to turn on the pump, open the valve, and the urine will be delivered to the sewer with absolutely no touching of urine, no spillage, and in most cases no odor. If there is any, the sink faucet can be run in conjunction and there will be none. In some cases other drains might be more accessible—the bathtub drain, for instance, or below the wash machine used water outlet if the doggy toilet is located in a utility room.

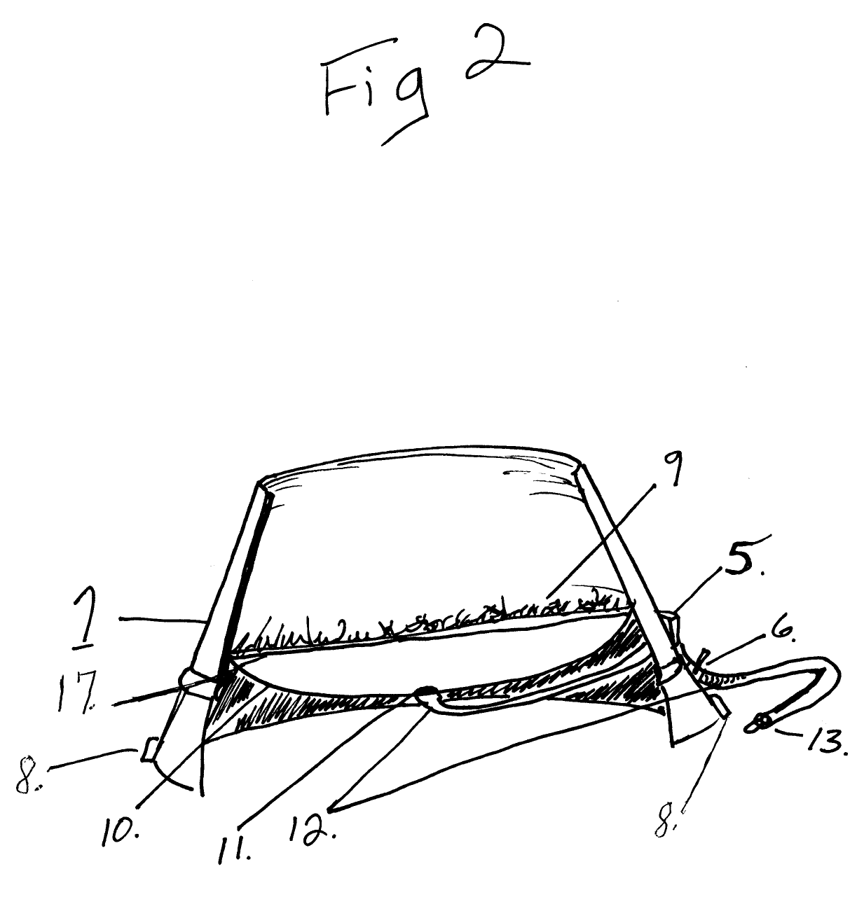

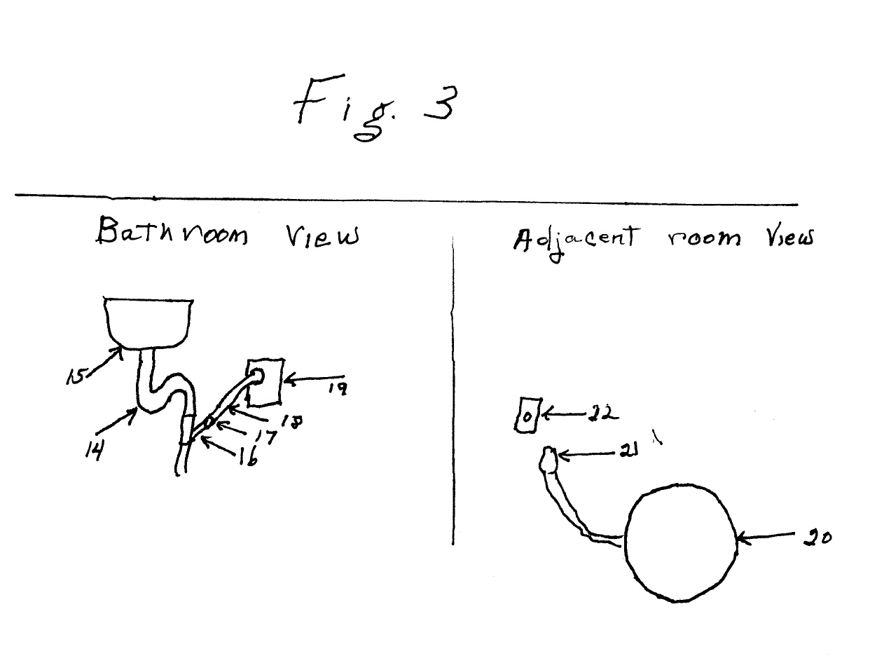

10. By the manner the invention is configured, there will be a built in spray guard (See FIGS. 2 and 3.) and railing to force him to do his circling within the confines of the invention.

11. The invention itself consists of a molded sturdy plastic tube (other material might be utilized such as metal) with a diameter of either 36″ (medium model) or (large model) 48″ that will accommodate quite a large dog. A shallow bowl like formation with a slight pitch to center is placed inside of the tube so that it is almost, but not quite touching the floor. This is important as it means the tube is supporting the structure, not the bowl, a more stable arrangement for if the bowl were the base, it would tend to tip. The bowl will act as a funnel. A piece of turf covers the bowl and is the surface upon which the dog walks and urinates.

12. The base end of the tube is curled up on itself much like one would cuff a pair of jeans, forming a lip of about 2″ on which the hose can be wound when not in use. See FIG. 2 (8).

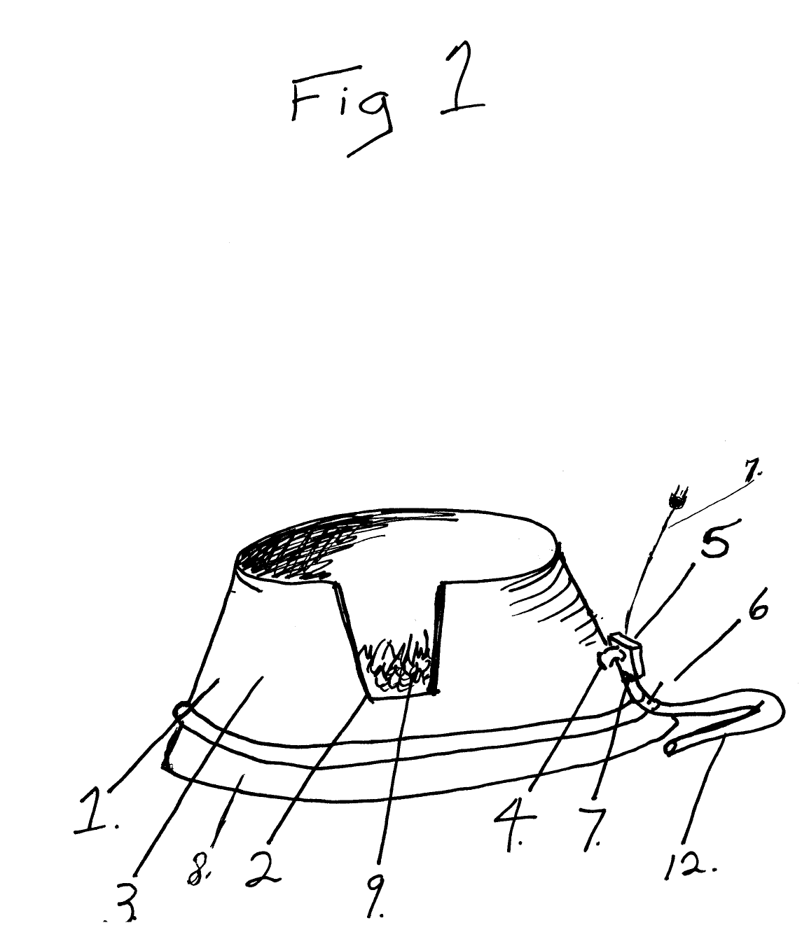

13. The bowl itself is found two thirds of the way into the depth of the tube; slightly less than the two thirds of the length of the tube will, then, still remain above and surrounding the turf. This upper part constitutes the splash guard and railing, although approximately one-sixth of this upper tube will be removed above the turf making an entrance and exit to the Circular Dog Toilet. See FIG. 1.

14. The bowl forms a funnel for the urine. In the center of the bottom of the bowl will be a hole where the hose is affixed. The hose will then be threaded thru the tube, and a small two-way pump FIG. 1 (5) will be attached. The hose after leaving the pump can be wound around the base of the structure within the lip so provided (See FIGS. 1. and 2.) when not in use. The hose coming from the funnel and to the pump will be translucent, so the urine inside of it will indicate to the owner when it is eminent that the pump should be turned on.

15. The feces deposited on the turf, unfortunately, must still be manually gathered and discarded. This invention has no remedy for that problem; but the responsible dog owner has always had to pick them up even when walking his pet outdoors.

16. Another hard fact is that while a large dog will find this invention quite satisfactory if he is trained upon it from puppy-hood, the successful training of an older dog who is accustomed to relieving himself outdoors might be problematical. Dogs who really hate inclement weather, will likely welcome it, but heartier ones may greet it with disdain.

### BRIEF DESCRIPTION OF THE SEVERAL VIEWS OF THE DRAWING

17. FIG. 1. A view of the top of the Circular Dog Toilet. This is the area on which the dog will perform his elimination functions. The turf is depicted, as is the splash-guard and railing. On the bottom of the picture, the entrance and exit is pictured.

18. FIG. 2. A side internal view of the formation showing the placement of the drain hole in the bowl, and turf above it, the hose leading out of the bowl to the pump attached to the outside of the tube and the hose extending from the pump. to the nozzle.

19. FIG. 3. This drawing shows how the Circular Dog Toilet can be installed into the sink drain below the trap, if the toilet is located in an adjoining room.

20. FIG. 4. A drawing of the drainage plate or lid found beneath the turf and supporting the turf with a plurality of holes for drainage.

### 21. PARTS LIST AND CORRESPONDING NUMBERS

1. Splash guard and railing 2. Exit and entrance. 3. Side of vertical tube 4. Hole where hose emerges from the tube (tank). 5. Two-way pump 6. Shut-off valve. 7. Electric cord coming from pump. 8. Lip to hold hose. 9. Turf. 10. Shallow bowl/funnel. 11. Drain hole. 12. ⅜″ Hose. 13. Nozzle of hose. 14. One and a half inch trap (the size could vary for other drains) trap. 15. Sink. 16. “Y” coupling. 17. Plastic drain plate of FIG. 4. 18. Extension of coupling. 19. Wall plate. 20. Circular toilet. 21. Three-eighths inch fitting, O/D male. 22. Three-eighths-fitting I/D female. 23. Gauge.

### DETAILED DESCRIPTION OF THE INVENTION

22. The Circular Dog Toilet with a Pump to Remove Urine falls into the class of “Dog Toilets”. In differs from other inventions of the class in three major ways: (A) being circular rather than rectangular as our the majority, (B) by pumping out the waste rather than having to have it manually removed, (C) by having the capabilities of being installed into a house drain and hence delivered into the central sewage system, (D) by having a larger frame which can accommodate larger breeds of dogs, in that the larger amount collected urine does not have to be manually removed, E) by being circular it conforms better to the natural movements of dogs who generally circle one or many more times before actually eliminating—with a rectangular structure, they step off and on before they are done, and often miss the intended target, and most importantly, (F) By transporting the urine by hose FIG. 1. and FIG. 2 (12), the pungent odor and stink of ammonia will be all but eliminated from the task of removing the urine; and by simultaneously pouring a pitcher of soapy water onto the turf and pumping it out of the structure the toilet will be far more hygienic than other dog toilets.

23. The embodiment of the invention is shown in FIG. 1. and FIG. 2. The process needed for installation into a sink drain, or through the cabinetry, options that may or may not be desired, is shown in FIG. 3.

24. The Circular Dog Toilet will appear much like the squat figure of the bottom half of a beer barrel. In other words it is housed in a wide tube. FIG. 1 and FIG. 2. (3). The circumference of the tube will be approximately 150 inches in the larger planned model, and in the smaller planned model it will be 113 inches although any size smaller or larger could be produced using the same pattern. It will stand 16 to 18 inches tall. The top of the tube is open with turf being the first layer and inserted into the tube a distance of one third of the tube's depth. FIGS. 1. and 2. (9). The surrounding siding of the tube (FIGS. 1. and 2. (1) constitute the railing and splash guard. An opening of about one/sixth of the diameter is cut into the tube forming an entrance and exit for the dog. FIG. 1. (2)

25. Working your way down into the tube, the layer below the turf is a lid-like sheet of plastic which is full of drain holes and supports the turf. FIG. 4.

26. Below the sheet of plastic (FIG. 4.) is a shallow bowl molded to the edges all around the tube. FIG. 2 (10). This bowl acts as a funnel receiving the urine from above where it has been sprayed onto the turf. At its center is a drain hole FIG. 2. (11) with the hose FIG. 2. (12) emerging. It in turn will go through a hole in the tube's sidewall FIG. 1(4) in and out of the two-way pump FIG. 1 and FIG. 2 (5), thence to the shut-off valve FIGS. 1. and 2. (6). The pump is connected to the wall electrical outlet as shown in FIG. 2(7).

27. When not in use, the hose FIGS. 1. and 2. (12) may be wound around the lip(8) so provided or if the option of installation is the approved one, it will continue as illustrated in FIG. 3. (12).

28. In FIG. 3 the entire installation process which is more or less identical to the way a garbage disposal is attached to a drain, with much the same delivery system of liquid as has an ice-maker in a refrigerator—the difference being this delivery system is bringing urine, while an ice machine is bringing pure water, i.e. View 1: In the adjacent room the hose comes from the reservoir in the circular toilet (20) by being pumped into the ⅜ inch hose and thru (21) the male fitting, to (22) the female fitting and the wall outlet. On the other side of the wall (The Bathroom View), the urine comes thru the wall plate (19) where it is coupled (17) to the Y extension (16) below the trap.

1. A formation of molded plastic, (but not limited to that material), FIGS. 1. and 2. becomes a circular dog toilet with a built-in splash guard which conforms to the instinctive circular motion that dogs exhibit when they urinate, thereby eliminating the missteps off of the platform and accidental urination on surrounds.

2. The embodiment of this invention in claim 1, (FIGS. 1. and 2.) in being circular, forms a funnel arrangement which is leak proof.

3. That the hose forms a gauge at it's exit point which will make it obvious when the structure should be emptied FIG. 1(22).

4. By pumping out hot, soapy water after use, the structure of claim 1, will be easily maintained odor free.

5. That the structure being so configured in claim 1, will support the weight of larger dogs than heretofore has been possible and still be satisfactory for their elimination and disposal of the urine.
In addition to claim 1., I further claim:

6. This is an innovation in dog toilets having a pump FIGS. 1., 2., and 3., (5) to deliver the urine via a small hose FIGS. 1., 2., and 3.(12) to a sink or human toilet, but not limited to those particular drains in the house. This installation can be installed as a permanent feature, but this not necessary for the delivery system to function.

7. I claim that this system of delivery (claim 6) will reduce or totally eliminate the pungent smell of urine in so delivering it to a drain.

8. The delivery system in claim 6, I maintain, is a an innovation that will make delivery of urine from a dog toilet to a drain more efficient and more hygienic than any former embodiments, as well as being relatively effortless without threat of mess.
